(19) United States
(12) Patent Application Publication
(10) Pub. No.: US 2024/0062184 A1
(43) Pub. Date: Feb. 22, 2024

(54) SYSTEM FOR EXECUTING WIRELESS RESOURCE TRANSFERS ON A PORTABLE COMPUTING DEVICE USING A SECURE DIGITAL TOKEN

(71) Applicant: BANK OF AMERICA CORPORATION, Charlotte, NC (US)

(72) Inventor: Maneesh Sethia, Hyderabad (IN)

(73) Assignee: BANK OF AMERICA CORPORATION, Charlotte, NC (US)

(21) Appl. No.: 17/892,456

(22) Filed: Aug. 22, 2022

(51) Int. Cl. G06Q 20/32; G06Q 20/06; G06Q 20/40

(52) U.S. Cl. CPC G06Q 20/3278; G06Q 20/065; G06Q 20/4014

(57) ABSTRACT

A system is provided for executing wireless resource transfers on a portable computing device using a secure digital token. In particular, in response to receiving a resource transfer request from a user, the system may dynamically generate a customized digital token in real-time based on information such as authentication credentials of the user, geolocation data, timestamps, and the like. The digital token may be validated and stored on a distributed register that may be accessible by an entity associated with the user. Upon validating the digital token, the entity's server may transmit the data needed to execute the resource transfer. In this way, the system may provide a secure and efficient way to execute resource transfers.

### FIELD OF THE INVENTION

The present invention embraces a system for executing wireless resource transfers on a portable computing device using a secure digital token.

### BACKGROUND

There is a need for an efficient and secure way to execute wireless resource transfers.

### SUMMARY

The following presents a simplified summary of one or more embodiments of the present invention, in order to provide a basic understanding of such embodiments. This summary is not an extensive overview of all contemplated embodiments and is intended to neither identify key or critical elements of all embodiments nor delineate the scope of any or all embodiments. Its sole purpose is to present some concepts of one or more embodiments of the present invention in a simplified form as a prelude to the more detailed description that is presented later.

A system is provided for executing wireless resource transfers on a portable computing device using a secure digital token. In particular, in response to receiving a resource transfer request from a user, the system may dynamically generate a customized digital token in real-time based on information such as authentication credentials of the user, geolocation data, timestamps, and the like. The digital token may be validated and stored on a distributed register that may be accessible by an entity associated with the user. Upon validating the digital token, the entity's server may transmit the data needed to execute the resource transfer. In this way, the system may provide a secure and efficient way to execute resource transfers.

Accordingly, embodiments of the present disclosure provide a system for executing wireless resource transfers on a portable computing device using a secure digital token, the system comprising at least one non-transitory storage device; and at least one processor coupled to the at least one non-transitory storage device, wherein the at least one processor is configured to receive an input from a user, wherein the input comprises a request to initiate a resource transfer; based on receiving the input, dynamically generate a non-fungible token based on authentication data associated with the user, location data associated with an endpoint device associated with the user, and a timestamp associated with the request to initiate the resource transfer; transmit the non-fungible token and resource transfer data associated with the resource transfer to one or more external nodes; in response to transmitting the non-fungible token and resource transfer data, receive user resource data from the one or more external nodes; and execute the resource transfer based on the user resource data.

In some embodiments, the resource transfer is associated with an object, wherein the at least one processor is further configured to detect that the user has selected an object; present object metadata on a display of the endpoint device associated with the user; and receive a confirmation input from the user to proceed with the resource transfer.

In some embodiments, detecting that the user has selected the object comprises detecting, based on an orientation of at least one eye of the user, that the user is looking at the object.

In some embodiments, the input comprises at least one of an eye movement, eye blink, or voice command.

In some embodiments, transmitting the non-fungible token to the one or more external nodes comprises transmitting the non-fungible token to a third-party computing device over a wireless communication channel, the wireless communication channel comprising a near-field communication (“NFC”) connection.

In some embodiments, the user resource data comprises resource account information, wherein executing the resource transfer is further based on the resource account information.

In some embodiments, the endpoint device associated with the user is a wearable pair of smart glasses.

Embodiments of the present disclosure also provide a computer program product for executing wireless resource transfers on a portable computing device using a secure digital token, the computer program product comprising a non-transitory computer-readable medium comprising code causing an apparatus to receive an input from a user, wherein the input comprises a request to initiate a resource transfer; based on receiving the input, dynamically generate a non-fungible token based on authentication data associated with the user, location data associated with an endpoint device associated with the user, and a timestamp associated with the request to initiate the resource transfer; transmit the non-fungible token and resource transfer data associated with the resource transfer to one or more external nodes; in response to transmitting the non-fungible token and resource transfer data, receive user resource data from the one or more external nodes; and execute the resource transfer based on the user resource data.

In some embodiments, the resource transfer is associated with an object, wherein the code further causes the apparatus to detect that the user has selected an object; present object metadata on a display of the endpoint device associated with the user; and receive a confirmation input from the user to proceed with the resource transfer.

In some embodiments, detecting that the user has selected the object comprises detecting, based on an orientation of at least one eye of the user, that the user is looking at the object.

In some embodiments, the input comprises at least one of an eye movement, eye blink, or voice command.

In some embodiments, transmitting the non-fungible token to the one or more external nodes comprises transmitting the non-fungible token to a third-party computing device over a wireless communication channel, the wireless communication channel comprising a near-field communication (“NFC”) connection.

In some embodiments, the endpoint device associated with the user is a wearable pair of smart glasses.

Embodiments of the present disclosure also provide a computer-implemented method for executing wireless resource transfers on a portable computing device using a secure digital token, the computer-implemented method comprising receiving an input from a user, wherein the input comprises a request to initiate a resource transfer; based on receiving the input, dynamically generating a non-fungible token based on authentication data associated with the user, location data associated with an endpoint device associated with the user, and a timestamp associated with the request to initiate the resource transfer; transmitting the non-fungible token and resource transfer data associated with the resource transfer to one or more external nodes; in response to transmitting the non-fungible token and resource transfer data, receiving user resource data from the one or more external nodes; and executing the resource transfer based on the user resource data.

In some embodiments, the resource transfer is associated with an object, wherein the computer-implemented method further comprises detecting that the user has selected an object; presenting object metadata on a display of the endpoint device associated with the user; and receiving a confirmation input from the user to proceed with the resource transfer.

In some embodiments, detecting that the user has selected the object comprises detecting, based on an orientation of at least one eye of the user, that the user is looking at the object.

In some embodiments, the input comprises at least one of an eye movement, eye blink, or voice command.

In some embodiments, transmitting the non-fungible token to the one or more external nodes comprises transmitting the non-fungible token to a third-party computing device over a wireless communication channel, the wireless communication channel comprising a near-field communication (“NFC”) connection.

In some embodiments, the user resource data comprises resource account information, wherein executing the resource transfer is further based on the resource account information.

In some embodiments, the endpoint device associated with the user is a wearable pair of smart glasses.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the invention in general terms, reference will now be made the accompanying drawings, wherein:

FIGS. 1A-1C illustrates technical components of an exemplary distributed computing environment for the system for executing wireless resource transfers on a portable computing device using a secure digital token, in accordance with an embodiment of the present disclosure;

FIG. 2A illustrates an exemplary DLT architecture, in accordance with an embodiment of the present disclosure;

FIG. 2B illustrates an exemplary transaction object, in accordance with an embodiment of the present disclosure;

FIG. 3A illustrates an exemplary process of creating an NFT 300, in accordance with an embodiment of the present disclosure; and

FIG. 3B illustrates an exemplary NFT 304 as a multi-layered documentation of a resource, in accordance with an embodiment of the present disclosure; and

FIG. 4 illustrates a process flow for executing wireless resource transfers on a portable computing device using a secure digital token, in accordance with an embodiment of the present disclosure.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

As used herein, an “entity” may be any institution employing information technology resources and particularly technology infrastructure configured for processing large amounts of data. Typically, these data can be related to the people who work for the organization, its products or services, the customers or any other aspect of the operations of the organization. As such, the entity may be any institution, group, association, financial institution, establishment, company, union, authority or the like, employing information technology resources for processing large amounts of data.

As described herein, a “user” may be an individual associated with an entity. As such, in some embodiments, the user may be an individual having past relationships, current relationships or potential future relationships with an entity. In some embodiments, the user may be an employee (e.g., an associate, a project manager, an IT specialist, a manager, an administrator, an internal operations analyst, or the like) of the entity or enterprises affiliated with the entity.

As used herein, a “user interface” may be a point of human-computer interaction and communication in a device that allows a user to input information, such as commands or data, into a device, or that allows the device to output information to the user. For example, the user interface includes a graphical user interface (GUI) or an interface to input computer-executable instructions that direct a processor to carry out specific functions. The user interface typically employs certain input and output devices such as a display, mouse, keyboard, button, touchpad, touch screen, microphone, speaker, LED, light, joystick, switch, buzzer, bell, and/or other user input/output device for communicating with one or more users.

As used herein, an “engine” may refer to core elements of an application, or part of an application that serves as a foundation for a larger piece of software and drives the functionality of the software. In some embodiments, an engine may be self-contained, but externally-controllable code that encapsulates powerful logic designed to perform or execute a specific type of function. In one aspect, an engine may be underlying source code that establishes file hierarchy, input and output methods, and how a specific part of an application interacts or communicates with other software and/or hardware. The specific components of an engine may vary based on the needs of the specific application as part of the larger piece of software. In some embodiments, an engine may be configured to retrieve resources created in other applications, which may then be ported into the engine for use during specific operational aspects of the engine. An engine may be configurable to be implemented within any general purpose computing system. In doing so, the engine may be configured to execute source code embedded therein to control specific features of the general purpose computing system to execute specific computing operations, thereby transforming the general purpose system into a specific purpose computing system.

As used herein, “authentication credentials” may be any information that can be used to identify of a user. For example, a system may prompt a user to enter authentication information such as a username, a password, a personal identification number (PIN), a passcode, biometric information (e.g., iris recognition, retina scans, fingerprints, finger veins, palm veins, palm prints, digital bone anatomy/structure and positioning (distal phalanges, intermediate phalanges, proximal phalanges, and the like), an answer to a security question, a unique intrinsic user activity, such as making a predefined motion with a user device. This authentication information may be used to authenticate the identity of the user (e.g., determine that the authentication information is associated with the account) and determine that the user has authority to access an account or system. In some embodiments, the system may be owned or operated by an entity. In such embodiments, the entity may employ additional computer systems, such as authentication servers, to validate and certify resources inputted by the plurality of users within the system. The system may further use its authentication servers to certify the identity of users of the system, such that other users may verify the identity of the certified users. In some embodiments, the entity may certify the identity of the users. Furthermore, authentication information or permission may be assigned to or required from a user, application, computing node, computing cluster, or the like to access stored data within at least a portion of the system.

It should also be understood that “operatively coupled,” as used herein, means that the components may be formed integrally with each other, or may be formed separately and coupled together. Furthermore, “operatively coupled” means that the components may be formed directly to each other, or to each other with one or more components located between the components that are operatively coupled together. Furthermore, “operatively coupled” may mean that the components are detachable from each other, or that they are permanently coupled together. Furthermore, operatively coupled components may mean that the components retain at least some freedom of movement in one or more directions or may be rotated about an axis (i.e., rotationally coupled, pivotally coupled). Furthermore, “operatively coupled” may mean that components may be electronically connected and/or in fluid communication with one another.

As used herein, an “interaction” may refer to any communication between one or more users, one or more entities or institutions, one or more devices, nodes, clusters, or systems within the distributed computing environment described herein. For example, an interaction may refer to a transfer of data between devices, an accessing of stored data by one or more nodes of a computing cluster, a transmission of a requested task, or the like.

As used herein, “determining” may encompass a variety of actions. For example, “determining” may include calculating, computing, processing, deriving, investigating, ascertaining, and/or the like. Furthermore, “determining” may also include receiving (e.g., receiving information), accessing (e.g., accessing data in a memory), and/or the like. Also, “determining” may include resolving, selecting, choosing, calculating, establishing, and/or the like. Determining may also include ascertaining that a parameter matches a predetermined criterion, including that a threshold has been met, passed, exceeded, and so on.

As used herein, “computing resource” or “resource” may generally refer to physical and/or virtual components or materials that are used in the operation of a computing device. Accordingly, examples of such resources may include processing power, memory allocation, cache space, storage space, data files, network connections and/or bandwidth, electrical power, input/output functions, and the like. Resources stored in a digital format (e.g., data records) may be referred to as “digital resources.”

“Cryptographic function” or “cryptographic algorithm” as used herein may refer to a set of logical and/or mathematical operations or processes that may be executed on a specified segment of data to produce a cryptographic output (or “cypher”). In some embodiments, the cryptographic algorithm may be an algorithm such as Rivest-Shamir-Adleman (“RSA”), Shamir's Secret Sharing (“SSS”), or the like. In other embodiments, the cryptographic algorithm may be a hash algorithm which may, given a specified data input, produce a cryptographic hash output value which is a fixed-length character string. Examples of such hash algorithms may include MDS, Secure Hash Algorithm/SHA, or the like. According, “hashing” or “hashed” as used herein may refer to the process of producing a hash output based on a data input into a hash algorithm.

As used herein, “non-fungible token” or “NFT” may be a digital resource which may be uniquely linked to a particular resource. An NFT may typically be stored on a distributed register that certifies ownership and authenticity of the resource, and exchangeable in a peer-to-peer network.

Digital resources such as NFTs may be stored within a network environment and used for a number of different purposes. Accordingly, the system provided herein provides a way to use dynamically generated NFTs to execute wireless resource transfers. In this regard, the system may receive an input from the user, where the input includes a request to execute a resource transfer. The request may be transmitted to the system through wireless communication technologies such as Wi-Fi, NFC, and/or the like, using a mobile computing device associated with the user (e.g., wearable smart technology such as smart glasses, the user's smart phone, and/or the like). Accordingly, the input from the user to initiate the request may include an input command to the mobile computing device, such as a gesture, eye movement or blinking, voice command, touch or haptic inputs, button presses or clicks, and/or the like. In some embodiments, the mobile computing device may first obtain and validate authentication credentials from the user before transmitting the request, where the authentication credentials may include data such as biometric data, a username and password, a session token, and/or the like.

In some embodiments, the request to execute the wireless resource transfer may include a dynamically generated NFT that may be generated using a custom smart contract. The smart contract may specify that the NFT is generated based on authentication credentials from the user (e.g., biometric data such as an iris scan image), geolocation data (e.g., GPS coordinates), a timestamp of the request, a mobile computing device identifier, and/or the like. In some embodiments, the mobile computing device may communicate with other nearby computing device to generate and/or transmit the request. In such embodiments, the NFT may further be generated based on third party computing device identifiers.

The NFT may be generated by the mobile computing device using the smart contract and subsequently transmitted to one or more entity networks (either directly or through a nearby third-party computing device), where the one or more entity networks include one or more distributed register nodes. The nodes may validate the NFT for addition to a distributed register that is stored across the various distributed register nodes, where validating the NFT may include executing one or more validation processes on the NFT. Once the NFT has been validated, the NFT may be appended (e.g., in a data record) to the distributed register. Subsequently, the nodes may transmit information associated with an account associated with the user to the mobile computing device of the user and/or the third-party computing device. The mobile computing device and/or the third-party computing device may then execute the resource transfer based on the information received from the nodes.

An exemplary embodiment is described as follows. It should be understood that the following embodiment is provided for illustrative purposes and is not intended to restrict the scope of the disclosure herein. In one embodiment, a user may wish to initiate a transaction on a vendor's premises, where the user may be wearing a wearable smart device such as smart glasses. The transaction may be a request to purchase a good provided by the vendor using funds from a user's account at a financial institution (e.g., an issuing financial institution). The user may initiate the request by pointing the user's eyes at the good to be purchased and providing a confirmation input to initiate the transaction, where the input may include an eye blink, gesture, button press, touch input, voice command, and/or the like. In this regard, the smart glasses may comprise one or more sensors configured to track the position, movement, and/or orientation of various structures within the user's eyes.

Once the transaction has been initiated, the smart device may dynamically generate an NFT, where the NFT may be generated on a per-transaction basis. The NFT may be generated based on various factors, which may include biometric data (e.g., iris biometric data), GPS coordinates associated with the smart glasses, a device identifier associated with the smart glasses, a timestamp of the requested transaction, and the like. In some embodiments, the factors may further include transaction data, such as recipient information, transaction amount, third party information (e.g., vendor information), transaction metadata (e.g., a description of goods or services purchased), and/or the like. The NFT may be encrypted to ensure the security of the data therein.

In some embodiments, the smart glasses may communicate and interact with a third party device (e.g., a point-of-sale system on the vendor's premises) to transmit the NFT. In such embodiments, the smart glasses may use a wireless communication method (e.g., Wi-Fi, NFC, and/or the like) to transmit the NFT to the PoS device. The PoS device may then transmit the NFT, along with any transaction data, to one or more nodes operated by one or more financial institutions. In some embodiments, the issuing financial institution and/or a second financial institution (e.g., an acquiring financial institution) may perform validation of the NFT.

For instance, in some embodiments, the system may require that the user is authenticated as part of the transaction process (e.g., by providing iris biometric data). In such embodiments, the system may initiate an onboarding process through which an image is captured of the user's eye or eyes (e.g., through the smart glasses of the user). The captured image may be analyzed by the system to extract the iris area and perform normalization of the iris. The normalized data may then be encoded and stored within an authentication database. Subsequently, the user may be authenticated by capturing a subsequent image of the user's eye, processing the subsequent image, and comparing the processed subsequent image with the original iris image data stored within the authentication database. Accordingly, in some embodiments, validating the NFT may comprise authenticating the user's biometric data in accordance with the process described above.

Validating the NFT may further include executing one or more validation processes to verify that the transaction request is authorized by the user. In this regard, validating the NFT may further include analyzing the geolocation data of the transaction request, the smart glass identifier, transaction data, and/or the like. If the system detects unusual activity with respect to the foregoing, the system may automatically block the transaction from being executed. For instance, if the transaction data comprises an unusually large transaction amount, if the transaction request is initiated in an unusual location based on the user's location history, or if the request was transmitted from a device that has not historically been used by the user to access the system, the system may determine that the transaction request is potentially unauthorized and block the transaction from being executed. In such cases, the system may present a notification (e.g., an error message) on the smart glasses to indicate that the transaction has been rejected.

Once the NFT has been validated, the issuing financial entity's nodes may transmit information associated with the user's account to the PoS device and/or the smart glasses, where the information may include an account identifier, routing number, authorization data, and/or the like. The PoS device and/or the smart glasses may then execute the transaction using the information provided by the nodes. In some embodiments, the system may further present a notification on the smart glasses of the user, where the notification indicates that the transaction has been successfully completed. In this way, the system provides a secure and efficient way to execute wireless resource transfers.

The present disclosure provides a technical solution to the technical problem of executing wireless resource transfers. Specifically, by dynamically generating NFTs on a real-time, on-demand basis, the system may ensure the security and authenticity of the associated resource transfers initiated by the user. Furthermore, through the use of smart wearable technology and wireless communication methods, the system may enhance the efficiency and usability of the resource transfer process.

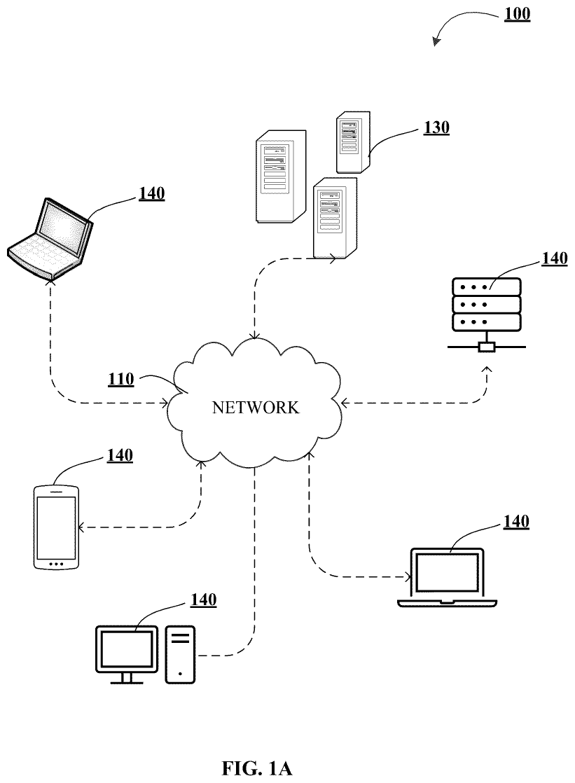

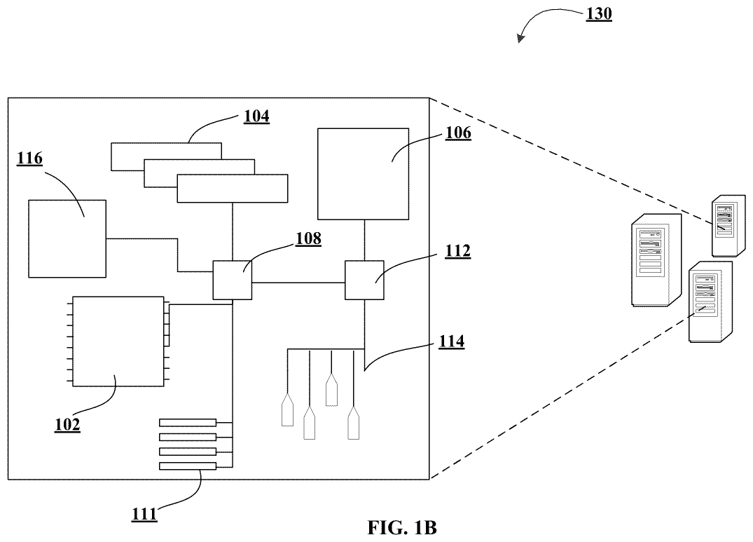

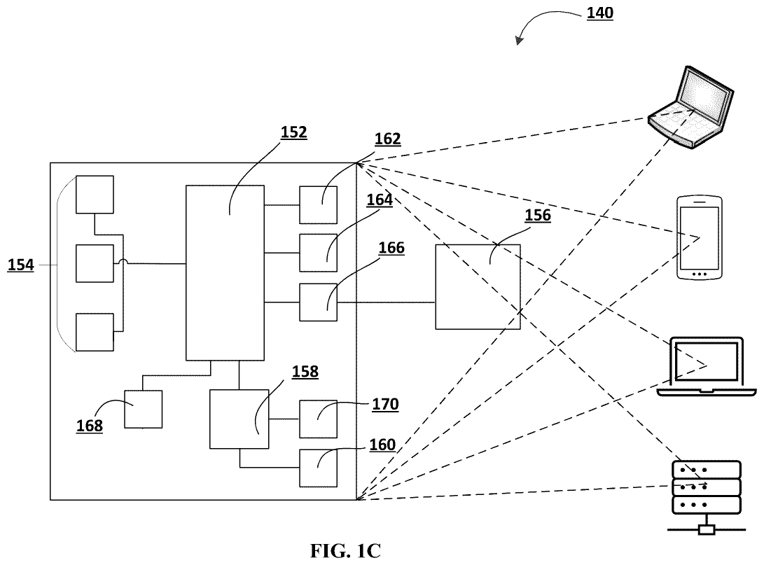

FIGS. 1A-1C illustrate technical components of an exemplary distributed computing environment 100 for the system for executing wireless resource transfers on a portable computing device using a secure digital token, in accordance with an embodiment of the invention. As shown in FIG. 1A, the distributed computing environment 100 contemplated herein may include a system 130, an end-point device(s) 140, and a network 110 over which the system 130 and end-point device(s) 140 communicate therebetween. FIG. 1A illustrates only one example of an embodiment of the distributed computing environment 100, and it will be appreciated that in other embodiments one or more of the systems, devices, and/or servers may be combined into a single system, device, or server, or be made up of multiple systems, devices, or servers. Also, the distributed computing environment 100 may include multiple systems, same or similar to system 130, with each system providing portions of the necessary operations (e.g., as a server bank, a group of blade servers, or a multi-processor system).

In some embodiments, the system 130 and the end-point device(s) 140 may have a client-server relationship in which the end-point device(s) 140 are remote devices that request and receive service from a centralized server, i.e., the system 130. In some other embodiments, the system 130 and the end-point device(s) 140 may have a peer-to-peer relationship in which the system 130 and the end-point device(s) 140 are considered equal and all have the same abilities to use the resources available on the network 110. Instead of having a central server (e.g., system 130) which would act as the shared drive, each device that is connect to the network 110 would act as the server for the files stored on it.

The system 130 may represent various forms of servers, such as web servers, database servers, file server, or the like, various forms of digital computing devices, such as laptops, desktops, video recorders, audio/video players, radios, workstations, or the like, or any other auxiliary network devices, such as wearable devices, Internet-of-things devices, electronic kiosk devices, mainframes, or the like, or any combination of the aforementioned.

The end-point device(s) 140 may represent various forms of electronic devices, including user input devices such as personal digital assistants, cellular telephones, smartphones, laptops, desktops, and/or the like, merchant input devices such as point-of-sale (POS) devices, electronic payment kiosks, and/or the like, electronic telecommunications device (e.g., automated teller machine (ATM)), and/or edge devices such as routers, routing switches, integrated access devices (IAD), and/or the like.

The network 110 may be a distributed network that is spread over different networks. This provides a single data communication network, which can be managed jointly or separately by each network. Besides shared communication within the network, the distributed network often also supports distributed processing. The network 110 may be a form of digital communication network such as a telecommunication network, a local area network (“LAN”), a wide area network (“WAN”), a global area network (“GAN”), the Internet, or any combination of the foregoing. The network 110 may be secure and/or unsecure and may also include wireless and/or wired and/or optical interconnection technology.

It is to be understood that the structure of the distributed computing environment and its components, connections and relationships, and their functions, are meant to be exemplary only, and are not meant to limit implementations of the inventions described and/or claimed in this document. In one example, the distributed computing environment 100 may include more, fewer, or different components. In another example, some or all of the portions of the distributed computing environment 100 may be combined into a single portion or all of the portions of the system 130 may be separated into two or more distinct portions.

FIG. 1B illustrates an exemplary component-level structure of the system 130, in accordance with an embodiment of the invention. As shown in FIG. 1B, the system 130 may include a processor 102, memory 104, input/output (I/O) device 116, and a storage device 110. The system 130 may also include a high-speed interface 108 connecting to the memory 104, and a low-speed interface 112 connecting to low speed bus 114 and storage device 110. Each of the components 102, 104, 108, 110, and 112 may be operatively coupled to one another using various buses and may be mounted on a common motherboard or in other manners as appropriate. As described herein, the processor 102 may include a number of subsystems to execute the portions of processes described herein. Each subsystem may be a self-contained component of a larger system (e.g., system 130) and capable of being configured to execute specialized processes as part of the larger system.

The processor 102 can process instructions, such as instructions of an application that may perform the functions disclosed herein. These instructions may be stored in the memory 104 (e.g., non-transitory storage device) or on the storage device 110, for execution within the system 130 using any subsystems described herein. It is to be understood that the system 130 may use, as appropriate, multiple processors, along with multiple memories, and/or I/O devices, to execute the processes described herein.

The memory 104 stores information within the system 130. In one implementation, the memory 104 is a volatile memory unit or units, such as volatile random access memory (RAM) having a cache area for the temporary storage of information, such as a command, a current operating state of the distributed computing environment 100, an intended operating state of the distributed computing environment 100, instructions related to various methods and/or functionalities described herein, and/or the like. In another implementation, the memory 104 is a non-volatile memory unit or units. The memory 104 may also be another form of computer-readable medium, such as a magnetic or optical disk, which may be embedded and/or may be removable. The non-volatile memory may additionally or alternatively include an EEPROM, flash memory, and/or the like for storage of information such as instructions and/or data that may be read during execution of computer instructions. The memory 104 may store, recall, receive, transmit, and/or access various files and/or information used by the system 130 during operation.

The storage device 106 is capable of providing mass storage for the system 130. In one aspect, the storage device 106 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier may be a non-transitory computer- or machine-readable storage medium, such as the memory 104, the storage device 104, or memory on processor 102.

The high-speed interface 108 manages bandwidth-intensive operations for the system 130, while the low speed controller 112 manages lower bandwidth-intensive operations. Such allocation of functions is exemplary only. In some embodiments, the high-speed interface 108 is coupled to memory 104, input/output (I/O) device 116 (e.g., through a graphics processor or accelerator), and to high-speed expansion ports 111, which may accept various expansion cards (not shown). In such an implementation, low-speed controller 112 is coupled to storage device 106 and low-speed expansion port 114. The low-speed expansion port 114, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The system 130 may be implemented in a number of different forms. For example, it may be implemented as a standard server, or multiple times in a group of such servers. Additionally, the system 130 may also be implemented as part of a rack server system or a personal computer such as a laptop computer. Alternatively, components from system 130 may be combined with one or more other same or similar systems and an entire system 130 may be made up of multiple computing devices communicating with each other.

FIG. 1C illustrates an exemplary component-level structure of the end-point device(s) 140, in accordance with an embodiment of the invention. As shown in FIG. 1C, the end-point device(s) 140 includes a processor 152, memory 154, an input/output device such as a display 156, a communication interface 158, and a transceiver 160, among other components. The end-point device(s) 140 may also be provided with a storage device, such as a microdrive or other device, to provide additional storage. Each of the components 152, 154, 158, and 160, are interconnected using various buses, and several of the components may be mounted on a common motherboard or in other manners as appropriate.

The processor 152 is configured to execute instructions within the end-point device(s) 140, including instructions stored in the memory 154, which in one embodiment includes the instructions of an application that may perform the functions disclosed herein, including certain logic, data processing, and data storing functions. The processor may be implemented as a chipset of chips that include separate and multiple analog and digital processors. The processor may be configured to provide, for example, for coordination of the other components of the end-point device(s) 140, such as control of user interfaces, applications run by end-point device(s) 140, and wireless communication by end-point device(s) 140.

The processor 152 may be configured to communicate with the user through control interface 164 and display interface 166 coupled to a display 156. The display 156 may be, for example, a TFT LCD (Thin-Film-Transistor Liquid Crystal Display) or an OLED (Organic Light Emitting Diode) display, or other appropriate display technology. The display interface 156 may comprise appropriate circuitry and configured for driving the display 156 to present graphical and other information to a user. The control interface 164 may receive commands from a user and convert them for submission to the processor 152. In addition, an external interface 168 may be provided in communication with processor 152, so as to enable near area communication of end-point device(s) 140 with other devices. External interface 168 may provide, for example, for wired communication in some implementations, or for wireless communication in other implementations, and multiple interfaces may also be used.

The memory 154 stores information within the end-point device(s) 140. The memory 154 can be implemented as one or more of a computer-readable medium or media, a volatile memory unit or units, or a non-volatile memory unit or units. Expansion memory may also be provided and connected to end-point device(s) 140 through an expansion interface (not shown), which may include, for example, a SIMM (Single In Line Memory Module) card interface. Such expansion memory may provide extra storage space for end-point device(s) 140 or may also store applications or other information therein. In some embodiments, expansion memory may include instructions to carry out or supplement the processes described above and may include secure information also. For example, expansion memory may be provided as a security module for end-point device(s) 140 and may be programmed with instructions that permit secure use of end-point device(s) 140. In addition, secure applications may be provided via the SIMM cards, along with additional information, such as placing identifying information on the SIMM card in a non-hackable manner.

The memory 154 may include, for example, flash memory and/or NVRAM memory. In one aspect, a computer program product is tangibly embodied in an information carrier. The computer program product contains instructions that, when executed, perform one or more methods, such as those described herein. The information carrier is a computer- or machine-readable medium, such as the memory 154, expansion memory, memory on processor 152, or a propagated signal that may be received, for example, over transceiver 160 or external interface 168.

In some embodiments, the user may use the end-point device(s) 140 to transmit and/or receive information or commands to and from the system 130 via the network 110. Any communication between the system 130 and the end-point device(s) 140 may be subject to an authentication protocol allowing the system 130 to maintain security by permitting only authenticated users (or processes) to access the protected resources of the system 130, which may include servers, databases, applications, and/or any of the components described herein. To this end, the system 130 may trigger an authentication subsystem that may require the user (or process) to provide authentication credentials to determine whether the user (or process) is eligible to access the protected resources. Once the authentication credentials are validated and the user (or process) is authenticated, the authentication subsystem may provide the user (or process) with permissioned access to the protected resources. Similarly, the end-point device(s) 140 may provide the system 130 (or other client devices) permissioned access to the protected resources of the end-point device(s) 140, which may include a GPS device, an image capturing component (e.g., camera), a microphone, and/or a speaker.

The end-point device(s) 140 may communicate with the system 130 through communication interface 158, which may include digital signal processing circuitry where necessary. Communication interface 158 may provide for communications under various modes or protocols, such as the Internet Protocol (IP) suite (commonly known as TCP/IP). Protocols in the IP suite define end-to-end data handling methods for everything from packetizing, addressing and routing, to receiving. Broken down into layers, the IP suite includes the link layer, containing communication methods for data that remains within a single network segment (link); the Internet layer, providing internetworking between independent networks; the transport layer, handling host-to-host communication; and the application layer, providing process-to-process data exchange for applications. Each layer contains a stack of protocols used for communications. In addition, the communication interface 158 may provide for communications under various telecommunications standards (2G, 3G, 4G, 5G, and/or the like) using their respective layered protocol stacks. These communications may occur through a transceiver 160, such as radio-frequency transceiver. In addition, short-range communication may occur, such as using a Bluetooth, Wi-Fi, or other such transceiver (not shown). In addition, GPS (Global Positioning System) receiver module 170 may provide additional navigation—and location-related wireless data to end-point device(s) 140, which may be used as appropriate by applications running thereon, and in some embodiments, one or more applications operating on the system 130.

The end-point device(s) 140 may also communicate audibly using audio codec 162, which may receive spoken information from a user and convert it to usable digital information. Audio codec 162 may likewise generate audible sound for a user, such as through a speaker, e.g., in a handset of end-point device(s) 140. Such sound may include sound from voice telephone calls, may include recorded sound (e.g., voice messages, music files, etc.) and may also include sound generated by one or more applications operating on the end-point device(s) 140, and in some embodiments, one or more applications operating on the system 130.

Various implementations of the distributed computing environment 100, including the system 130 and end-point device(s) 140, and techniques described here can be realized in digital electronic circuitry, integrated circuitry, specially designed ASICs (application specific integrated circuits), computer hardware, firmware, software, and/or combinations thereof.

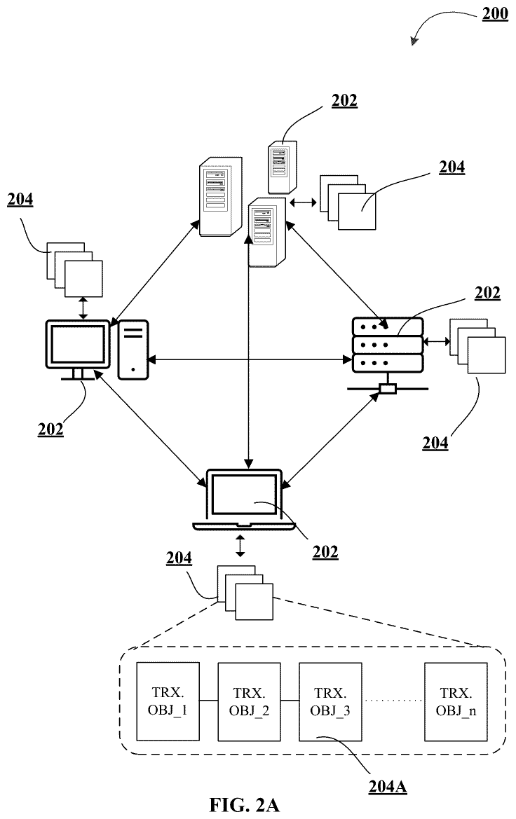

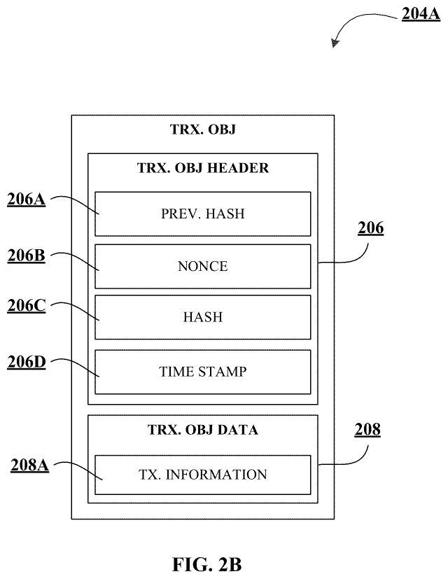

FIGS. 2A-2B illustrate an exemplary distributed ledger technology (DLT) architecture, in accordance with an embodiment of the invention. DLT may refer to the protocols and supporting infrastructure that allow computing devices (peers) in different locations to propose and validate transactions and update records in a synchronized way across a network. Accordingly, DLT is based on a decentralized model, in which these peers collaborate and build trust over the network. To this end, DLT involves the use of potentially peer-to-peer protocol for a cryptographically secured distributed ledger (which may also be referred to herein as a “distributed register”) of transactions represented as transaction objects that are linked. As transaction objects each contain information about the transaction object previous to it, they are linked with each additional transaction object, reinforcing the ones before it. Therefore, distributed ledgers are resistant to modification of their data because once recorded, the data in any given transaction object cannot be altered retroactively without altering all subsequent transaction objects.

To permit transactions and agreements to be carried out among various peers without the need for a central authority or external enforcement mechanism, DLT uses smart contracts. Smart contracts are computer code that automatically executes all or parts of an agreement and is stored on a DLT platform. The code can either be the sole manifestation of the agreement between the parties or might complement a traditional text-based contract and execute certain provisions, such as transferring funds from Party A to Party B. The code itself is replicated across multiple nodes (peers) and, therefore, benefits from the security, permanence, and immutability that a distributed ledger offers. That replication also means that as each new transaction object is added to the distributed ledger, the code is, in effect, executed. If the parties have indicated, by initiating a transaction, that certain parameters have been met, the code will execute the step triggered by those parameters. If no such transaction has been initiated, the code will not take any steps.

Various other specific-purpose implementations of distributed ledgers have been developed. These include distributed domain name management, decentralized crowd-funding, synchronous/asynchronous communication, decentralized real-time ride sharing and even a general purpose deployment of decentralized applications. In some embodiments, a distributed ledger may be characterized as a public distributed ledger, a consortium distributed ledger, or a private distributed ledger. A public distributed ledger is a distributed ledger that anyone in the world can read, anyone in the world can send transactions to and expect to see them included if they are valid, and anyone in the world can participate in the consensus process for determining which transaction objects get added to the distributed ledger and what the current state each transaction object is. A public distributed ledger is generally considered to be fully decentralized. On the other hand, fully private distributed ledger is a distributed ledger whereby permissions are kept centralized with one entity. The permissions may be public or restricted to an arbitrary extent. And lastly, a consortium distributed ledger is a distributed ledger where the consensus process is controlled by a pre-selected set of nodes; for example, a distributed ledger may be associated with a number of member institutions (say 15), each of which operate in such a way that the at least 10 members must sign every transaction object in order for the transaction object to be valid. The right to read such a distributed ledger may be public or restricted to the participants. These distributed ledgers may be considered partially decentralized.

As shown in FIG. 2A, the exemplary DLT architecture 200 includes a distributed ledger 204 being maintained on multiple devices (nodes) 202 that are authorized to keep track of the distributed ledger 204. For example, these nodes 202 may be computing devices such as system 130 and client device(s) 140. One node 202 in the DLT architecture 200 may have a complete or partial copy of the entire distributed ledger 204 or set of transactions and/or transaction objects 204A on the distributed ledger 204. Transactions are initiated at a node and communicated to the various nodes in the DLT architecture. Any of the nodes can validate a transaction, record the transaction to its copy of the distributed ledger, and/or broadcast the transaction, its validation (in the form of a transaction object) and/or other data to other nodes.

As shown in FIG. 2B, an exemplary transaction object 204A may include a transaction header 206 and a transaction object data 208. The transaction header 206 may include a cryptographic hash of the previous transaction object 206A, a nonce 206B—a randomly generated 32-bit whole number when the transaction object is created, cryptographic hash of the current transaction object 206C wedded to the nonce 206B, and a time stamp 206D. The transaction object data 208 may include transaction information 208A being recorded. Once the transaction object 204A is generated, the transaction information 208A is considered signed and forever tied to its nonce 206B and hash 206C. Once generated, the transaction object 204A is then deployed on the distributed ledger 204. At this time, a distributed ledger address is generated for the transaction object 204A, i.e., an indication of where it is located on the distributed ledger 204 and captured for recording purposes. Once deployed, the transaction information 208A is considered recorded in the distributed ledger 204.

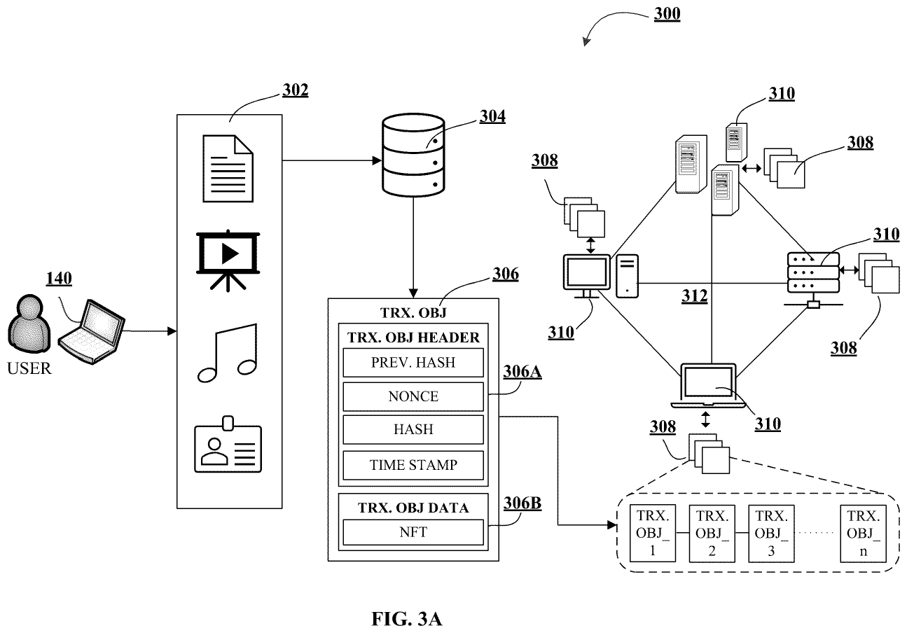

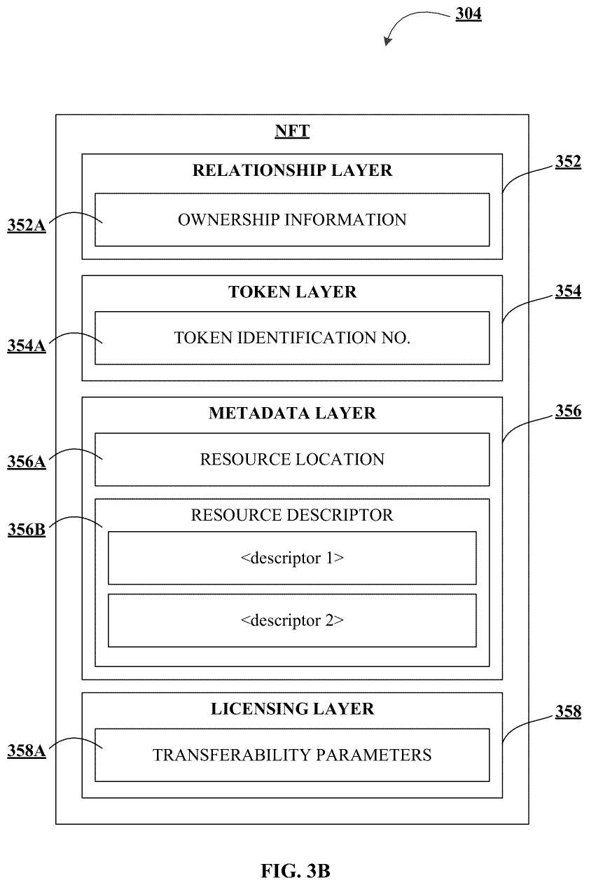

FIG. 3A illustrates an exemplary process of creating an NFT 300, in accordance with an embodiment of the invention. As shown in FIG. 3A, to create or “mint” an NFT, a user (e.g., NFT owner) may identify, using a user input device 140, resources 302 that the user wishes to mint as an NFT. Typically, NFTs are minted from digital objects that represent both tangible and intangible objects. These resources 302 may include a piece of art, music, collectible, videos, real-world items such as artwork and real estate, or any other presumed valuable object. These resources 302 are then digitized into a proper format to produce an NFT 304. The NFT 304 may be a multi-layered documentation that identifies the resources 302 but also evidences various transaction conditions associated therewith, as described in more detail with respect to FIG. 3A.

To record the NFT in a distributed ledger, a transaction object 306 for the NFT 304 is created. The transaction object 306 may include a transaction header 306A and a transaction object data 306B. The transaction header 306A may include a cryptographic hash of the previous transaction object, a nonce—a randomly generated 32-bit whole number when the transaction object is created, cryptographic hash of the current transaction object wedded to the nonce, and a time stamp. The transaction object data 306B may include the NFT 304 being recorded. Once the transaction object 306 is generated, the NFT 204 is considered signed and forever tied to its nonce and hash. Once generated, the transaction object 306 is then deployed in the distributed ledger 308. At this time, a distributed ledger address is generated for the transaction object 306, i.e., an indication of where it is located on the distributed ledger 308 and captured for recording purposes. Once deployed, the NFT 304 is linked permanently to its hash and the distributed ledger 308, and is considered recorded in the distributed ledger 308, thus concluding the minting process

As shown in FIG. 3A, the distributed ledger 308 may be maintained on multiple devices (nodes) 310 that are authorized to keep track of the distributed ledger 308. For example, these nodes 310 may be computing devices such as system 130 and client device(s) 130. One node 310 may have a complete or partial copy of the entire distributed ledger 308 or set of transactions and/or transaction objects on the distributed ledger 308. Transactions, such as the creation and recordation of a NFT, are initiated at a node and communicated to the various nodes. Any of the nodes can validate a transaction, record the transaction to its copy of the distributed ledger, and/or broadcast the transaction, its validation (in the form of a transaction object) and/or other data to other nodes.

FIG. 3B illustrates an exemplary NFT 304 as a multi-layered documentation of a resource, in accordance with an embodiment of an invention. As shown in FIG. 3B, the NFT may include at least relationship layer 352, a token layer 354, a metadata layer 356, and a licensing layer 358. The relationship layer 352 may include ownership information 352A, including a map of various users that are associated with the resource and/or the NFT 304, and their relationship to one another. For example, if the NFT 304 is purchased by buyer B1 from a seller S 1, the relationship between B1 and Si as a buyer-seller is recorded in the relationship layer 352. In another example, if the NFT 304 is owned by O1 and the resource itself is stored in a storage facility by storage provider SP1, then the relationship between O1 and SP1 as owner-file storage provider is recorded in the relationship layer 352. The token layer 354 may include a token identification number 354A that is used to identify the NFT 304. The metadata layer 356 may include at least a file location 356A and a file descriptor 356B. The file location 356A may provide information associated with the specific location of the resource 302. Depending on the conditions listed in the smart contract underlying the distributed ledger 308, the resource 302 may be stored on-chain, i.e., directly on the distributed ledger 308 along with the NFT 304, or off-chain, i.e., in an external storage location. The file location 356A identifies where the resource 302 is stored. The file descriptor 356B may include specific information associated with the source itself 302. For example, the file descriptor 356B may include information about the supply, authenticity, lineage, provenance of the resource 302. The licensing layer 358 may include any transferability parameters 358B associated with the NFT 304, such as restrictions and licensing rules associated with purchase, sale, and any other types of transfer of the resource 302 and/or the NFT 304 from one person to another. Those skilled in the art will appreciate that various additional layers and combinations of layers can be configured as needed without departing from the scope and spirit of the invention.

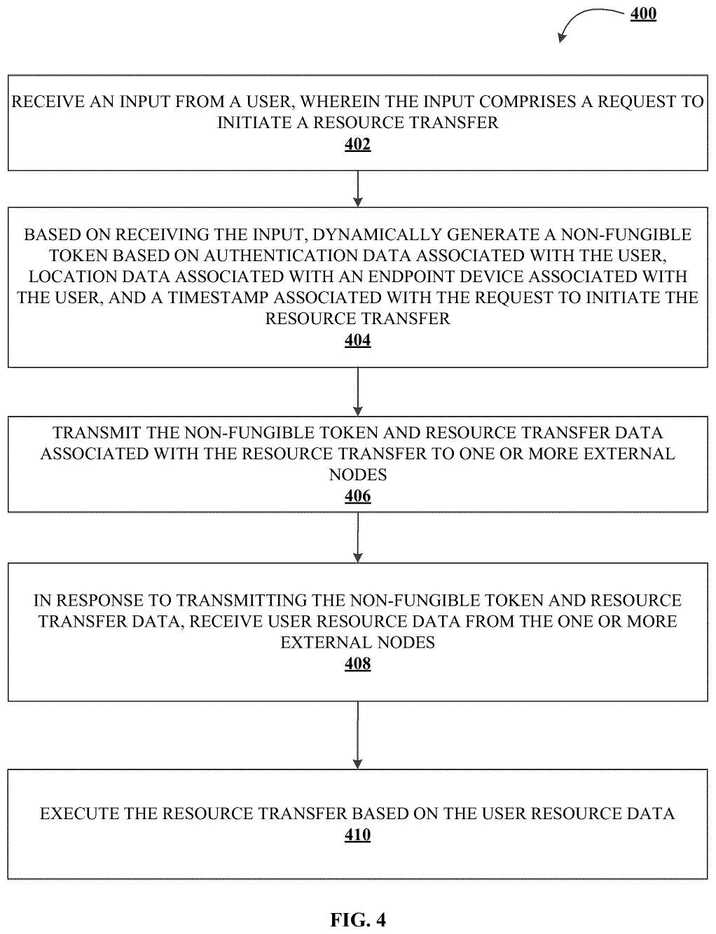

FIG. 4 illustrates a process flow 400 for executing wireless resource transfers on a portable computing device using a secure digital token, in accordance with an embodiment of the present disclosure. The process begins at block 402, where the system receives an input from a user, wherein the input comprises a request to initiate a resource transfer. Examples of such inputs may include an eye movement or blink, hand or finger gesture, voice command, button press, or the like. In an exemplary embodiment, the user may be wearing a pair of smart glasses while located within a vendor's premises. In such an embodiment, the request to initiate a resource transfer may be a request to purchase an object that is offered by the vendor. In such an embodiment, the user may focus the user's eyes on the items. The smart glasses, which may be configured to track the eye position, gaze, and movement of the user's eyes, may detect that the user's eyes are oriented toward the object. Furthermore, the user may provide an additional input (e.g., an eye blink) to select the object. In other embodiments, the system may detect that the user has selected the object based on other types of inputs, such as button presses, voice commands, and/or the like.

Once the user has selected the object, the system may be configured to display various types of object metadata on the display or screen of the smart glasses, where the object metadata may include an object identifier, a description of the object, a cost of the object, an image representation of the object, and/or the like. The system may further display one or more queries on the display for additional user input, such as a confirmation of the request for a resource transfer (e.g., the user is queried to confirm the purchase of the object). In some embodiments, the queries may further include a request for the user to select a resource transfer method (e.g., a particular payment method or account) to be used for the purchase. Once the user provides an input that confirms the resource transfer, the system may move on to the next step in the process.

The process continues to block 404, where the system based on receiving the input, dynamically generates a non-fungible token based on authentication data associated with the user, location data associated with an endpoint device associated with the user, and a timestamp associated with the request to initiate the resource transfer. The non-fungible token may be generated by the system on an on-demand basis (e.g., per resource transfer) in response to detecting that the user has confirmed the resource transfer. In this regard, the non-fungible token may be generated based on authentication data such as iris biometric data captured by the system (e.g., through a camera or sensor within the smart glasses). In such embodiments, the user may initiate an authentication data onboarding process in which an initial biometric sample is obtained from the user.

In the case of iris biometric data, the system may capture an image of the user's eyes, isolate and extract an area of the image corresponding to at least one iris of the user, perform removal of noise and/or artifacts (e.g., removal of eyelids or eyelashes), perform normalization of the iris area, and encode the normalized image data to be stored within an authentication database. Subsequently, each time that the user initiates a resource transfer using the system, the user may provide current iris biometric data that may be compared by the system to the biometric data stored within the authentication database. If a match is detected between the current biometric data and the data stored within the authentication database, the system may allow the resource transfer to proceed. However, if a mismatch is detected, the system may automatically block the resource transfer from proceeding.

The non-fungible token may further be generated based on location data of the smart glasses (e.g., GPS coordinate data), timestamp associated with the requested resource transfer, a device identifier associated with the smart glasses (e.g., a MAC address of a wireless communication adapter within the smart glasses, a serial number of the smart glasses, and/or the like), resource transfer data (e.g., recipient information, resource amounts, object descriptions, and/or the like), and/or the like. In this way, each non-fungible token may uniquely be associated with a particular resource transfer at a particular point in time.

The process continues to block 406, where the system transmits the non-fungible token and resource transfer data associated with the resource transfer to one or more external nodes. In some embodiments, the non-fungible token and/or the resource transfer data may be transmitted to the external nodes through a third-party computing device that serves as an intermediary within the network. In this regard, the third-party computing device may be a point-of-sale device on the entity's premises. Accordingly, in such embodiments, the smart glasses may transmit the NFT to the third-party computing device through a wireless communication channel, such as an NFC connection, Bluetooth connection, Wi-Fi connection, and/or the like.

The external nodes may host a distributed data register comprising one or more data blocks, where the data blocks may comprise information related to resource transfers. In this regard, the external nodes may perform one or more validation checks on the NFT and/or the resource transfer data received from the user's computing device and/or the third-party computing device. Examples of the one or more validation checks may comprise, for instance, that the received biometric data matches the biometric data within the authentication database, that the location data is consistent with historical location data associated with the user computing device, that the resource transfer amounts and/or types (e.g., the nature of the goods or services purchased) are consistent with historical resource transfer data associated with the user, and the like. Once the NFT has been validated, the system may append a data record to the data register, wherein the data record comprises the NFT. In this way, the distributed data register may form a secure, immutable record of resource transfers initiated by the user. Upon adding the data record to the distributed data register, the external nodes may look up and retrieve resource account information (or “user resource data”) associated with the user (e.g., account number, resource amount within the account, and the like), and subsequently transmit the resource account information to the user computing device and/or the third-party computing device.

The process continues to block 408, where the system in response to transmitting the non-fungible token and resource transfer data, receives user resource data from the one or more external nodes. The user resource data may then be used by the smart glasses and/or the point-of-sale device to complete the transaction initiated by the user.

The process continues to block 410, where the system executes the resource transfer based on the user resource data. For instance, the point-of-sale device may use the account information within the user resource data to execute the transaction based on the resource transfer data. For example, if the transaction is a purchase of a good, the system may use the account information within the user resource data to transfer funds from the user resource account in the amount of the purchase price for the good.

In some embodiments, the system may be configured to display a confirmation notification on the smart glasses of the user, where the confirmation notification indicates that the resource transfer has been successfully executed. In some embodiments, the confirmation notification may further indicate other information regarding the resource transfer, such as the amount of resources used for the resource transfer, a timestamp indicating the time at which the resource transfer was confirmed, the resource account or type that has been used to complete the resource transfer, and/or the like. In this way, the system provides a secure and efficient way to perform wireless resource transfers.

As will be appreciated by one of ordinary skill in the art, the present invention may be embodied as an apparatus (including, for example, a system, a machine, a device, a computer program product, and/or the like), as a method (including, for example, a business process, a computer-implemented process, and/or the like), or as any combination of the foregoing. Accordingly, embodiments of the present invention may take the form of an entirely software embodiment (including firmware, resident software, micro-code, and the like), an entirely hardware embodiment, or an embodiment combining software and hardware aspects that may generally be referred to herein as a “system.” Furthermore, embodiments of the present invention may take the form of a computer program product that includes a computer-readable storage medium having computer-executable program code portions stored therein. As used herein, a processor may be “configured to” perform a certain function in a variety of ways, including, for example, by having one or more special-purpose circuits perform the functions by executing one or more computer-executable program code portions embodied in a computer-readable medium, and/or having one or more application-specific circuits perform the function.

It will be understood that any suitable computer-readable medium may be utilized. The computer-readable medium may include, but is not limited to, a non-transitory computer-readable medium, such as a tangible electronic, magnetic, optical, infrared, electromagnetic, and/or semiconductor system, apparatus, and/or device. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as a propagation signal including computer-executable program code portions embodied therein.

It will also be understood that one or more computer-executable program code portions for carrying out the specialized operations of the present invention may be required on the specialized computer include object-oriented, scripted, and/or unscripted programming languages, such as, for example, Java, Perl, Smalltalk, C++, SAS, SQL, Python, Objective C, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F #.

It will further be understood that some embodiments of the present invention are described herein with reference to flowchart illustrations and/or block diagrams of systems, methods, and/or computer program products. It will be understood that each block included in the flowchart illustrations and/or block diagrams, and combinations of blocks included in the flowchart illustrations and/or block diagrams, may be implemented by one or more computer-executable program code portions. These computer-executable program code portions execute via the processor of the computer and/or other programmable data processing apparatus and create mechanisms for implementing the steps and/or functions represented by the flowchart(s) and/or block diagram block(s).

It will also be understood that the one or more computer-executable program code portions may be stored in a transitory or non-transitory computer-readable medium (e.g., a memory, and the like) that can direct a computer and/or other programmable data processing apparatus to function in a particular manner, such that the computer-executable program code portions stored in the computer-readable medium produce an article of manufacture, including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with operator and/or human-implemented steps in order to carry out an embodiment of the present invention.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

What is claimed is:

1. A system for executing wireless resource transfers on a portable computing device using a secure digital token, the system comprising:
at least one non-transitory storage device; and
at least one processor coupled to the at least one non-transitory storage device, wherein the at least one processor is configured to:
receive an input from a user, wherein the input comprises a request to initiate a resource transfer;
based on receiving the input, dynamically generate a non-fungible token based on authentication data associated with the user, location data associated with an endpoint device associated with the user, and a timestamp associated with the request to initiate the resource transfer;
transmit the non-fungible token and resource transfer data associated with the resource transfer to one or more external nodes;
in response to transmitting the non-fungible token and resource transfer data, receive user resource data from the one or more external nodes; and
execute the resource transfer based on the user resource data.

2. The system of claim 1, wherein the resource transfer is associated with an object, wherein the at least one processor is further configured to:
detect that the user has selected an object;
present object metadata on a display of the endpoint device associated with the user; and
receive a confirmation input from the user to proceed with the resource transfer.

3. The system of claim 2, wherein detecting that the user has selected the object comprises detecting, based on an orientation of at least one eye of the user, that the user is looking at the object.

4. The system of claim 1, wherein the input comprises at least one of an eye movement, eye blink, or voice command.

5. The system of claim 1, wherein transmitting the non-fungible token to the one or more external nodes comprises transmitting the non-fungible token to a third-party computing device over a wireless communication channel, the wireless communication channel comprising a near-field communication (“NFC”) connection.

6. The system of claim 1, wherein the user resource data comprises resource account information, wherein executing the resource transfer is further based on the resource account information.

7. The system of claim 1, wherein the endpoint device associated with the user is a wearable pair of smart glasses.

8. A computer program product for executing wireless resource transfers on a portable computing device using a secure digital token, the computer program product comprising a non-transitory computer-readable medium comprising code causing an apparatus to:
receive an input from a user, wherein the input comprises a request to initiate a resource transfer;
based on receiving the input, dynamically generate a non-fungible token based on authentication data associated with the user, location data associated with an endpoint device associated with the user, and a timestamp associated with the request to initiate the resource transfer;
transmit the non-fungible token and resource transfer data associated with the resource transfer to one or more external nodes;
in response to transmitting the non-fungible token and resource transfer data, receive user resource data from the one or more external nodes; and
execute the resource transfer based on the user resource data.

9. The computer program product of claim 8, wherein the resource transfer is associated with an object, wherein the code further causes the apparatus to:
detect that the user has selected an object;
present object metadata on a display of the endpoint device associated with the user; and
receive a confirmation input from the user to proceed with the resource transfer.

10. The computer program product of claim 9, wherein detecting that the user has selected the object comprises detecting, based on an orientation of at least one eye of the user, that the user is looking at the object.

11. The computer program product of claim 8, wherein the input comprises at least one of an eye movement, eye blink, or voice command.

12. The computer program product of claim 8, wherein transmitting the non-fungible token to the one or more external nodes comprises transmitting the non-fungible token to a third-party computing device over a wireless communication channel, the wireless communication channel comprising a near-field communication (“NFC”) connection.

13. The computer program product of claim 8, wherein the endpoint device associated with the user is a wearable pair of smart glasses.

14. A computer-implemented method for executing wireless resource transfers on a portable computing device using a secure digital token, the computer-implemented method comprising:
receiving an input from a user, wherein the input comprises a request to initiate a resource transfer;
based on receiving the input, dynamically generating a non-fungible token based on authentication data associated with the user, location data associated with an endpoint device associated with the user, and a timestamp associated with the request to initiate the resource transfer;
transmitting the non-fungible token and resource transfer data associated with the resource transfer to one or more external nodes;
in response to transmitting the non-fungible token and resource transfer data, receiving user resource data from the one or more external nodes; and
executing the resource transfer based on the user resource data.

15. The computer-implemented method of claim 14, wherein the resource transfer is associated with an object, wherein the computer-implemented method further comprises:
detecting that the user has selected an object;
presenting object metadata on a display of the endpoint device associated with the user; and
receiving a confirmation input from the user to proceed with the resource transfer.

16. The computer-implemented method of claim 15, wherein detecting that the user has selected the object comprises detecting, based on an orientation of at least one eye of the user, that the user is looking at the object.

17. The computer-implemented method of claim 14, wherein the input comprises at least one of an eye movement, eye blink, or voice command.

18. The computer-implemented method of claim 14, wherein transmitting the non-fungible token to the one or more external nodes comprises transmitting the non-fungible token to a third-party computing device over a wireless communication channel, the wireless communication channel comprising a near-field communication (“NFC”) connection.

19. The computer-implemented method of claim 14, wherein the user resource data comprises resource account information, wherein executing the resource transfer is further based on the resource account information.

20. The computer-implemented method of claim 14, wherein the endpoint device associated with the user is a wearable pair of smart glasses.
